(19) United States
(12) Patent Application Publication
(10) Pub. No.: US 2008/0083009 A1
(43) Pub. Date: Apr. 3, 2008

(54) POLICY FAULT

(75) Inventors: Christopher G. Kaler, Sammamish, WA (US); Douglas A. Walter, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 11/537,029

(22) Filed: Sep. 29, 2006

(51) Int. Cl. H04L 9/00

(52) U.S. Cl. 726/1

(57) ABSTRACT

Communicating and requesting specialized policy information. A message is sent by a client to a service which provides the services requested by the message or a specialized processor that evaluates messages. The message is evaluated for compliance with a policy particular to the message. If the message does not comply with a policy particular to the message, policy information is sent, where the policy information indicates the correct policy particular to the message. In one embodiment, if the message complies with a policy particular to the message, policy information is sent, where the policy information indicates that the message complies with a policy particular to the message.

### BACKGROUND

### Background and Relevant Art

Computers and computing systems have affected nearly every aspect of modern living. Computers are generally involved in work, recreation, healthcare, transportation, entertainment, household management, etc. The functionality of computers has also been enhanced by their ability to be interconnected through various network connections.

Modern computers often include functionality for connecting to other computers. For example, a modern home computer may include a modem for dial-up connection to internet service provider servers, email servers, directly to other computers, etc. In addition, nearly all home computers come equipped with a network interface port such as an RJ-45 Ethernet port complying with IEE 802.3 standards. This network port, as well as other connections such as various wireless and hardwired connections can be used to interconnect computers.

Systems communicating with one another commonly facilitate that communication by complying with particular policies. For many communications, general policies may be sufficient. These general policies may be well known policies that are included in the software code of communication modules within a computing system.

As noted, general policies are often sufficient for a large percentage of communications. However, in some cases specialized policies may be desirable or required by one or more of the parties to a communication. In many cases, it may not be practical to have well known rules for every specific communication. For example, the ability to extend a system would require recompiling source code for a number of systems every time a new syntax or policy is added. Additionally, some policies may be specific to a specific organization. Including the polices generally for all systems results in unnecessary storage and processing.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

A number of embodiments are described herein which facilitate communicating specialized policy information. For example, in one embodiment, which may be performed in a computing environment, a method of discerning appropriate policy for a particular message is illustrated. The method includes sending a message. In response to sending the message, policy information is received. The policy information either indicates that the message complies with a policy particular to the message or indicates the correct policy if the message does not comply with the policy particular to the message.

In an alternative embodiment, a method of providing appropriate policy for a particular message is illustrated; The method includes receiving a message. The message is evaluated for compliance with a policy particular to the message. If the message does not comply with a policy particular to the message, policy information is sent, where the policy information indicates the correct policy particular to the message. In one embodiment, if the message complies with a policy particular to the message, policy information is sent, where the policy information indicates that the message complies with a policy particular to the message.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1A illustrates an example of a client communicating with a service;

FIG. 1B illustrates an example of a client communicating with a service and a specialized processor;

FIG. 1C illustrates an example of a client communicating with a specialized processor included in a service;

FIG. 2 illustrates an example of a method of discerning policy information; and

FIG. 3 illustrates an example of a method of providing policy information.

### DETAILED DESCRIPTION

Embodiments herein may comprise a special purpose or general-purpose computer including various computer hardware, as discussed in greater detail below.

Computing systems often have need to access the functionality of services. Often generalized uniform policy rules are sufficient for general communications between a client computing system and a service. However, often specialized policy rules may be required or desirable for a particular interaction between a computing system and a service or for particular circumstances. For example, in an online transaction, certain policies may be implemented for certain types of transactions. If an on-line transaction exceeds a particular dollar amount, there may be a desire to require additional verification information. If the on-line transaction is originated from a location where fraud is prevalent, there may be a desire to require additional verification. If a transaction is one involving a particular party, there may be a desire or requirement for additional verification, or specialized policy considerations particular to the party. Other particularized policy rules may apply to specific environments, specific geographies, etc. One embodiment described herein facilitates the discovery of specialized policies for a given particular message by use of the message itself. Additionally, some embodiments described herein include functionality for checking a message for compliance and/or returning policy information particular to a given message.

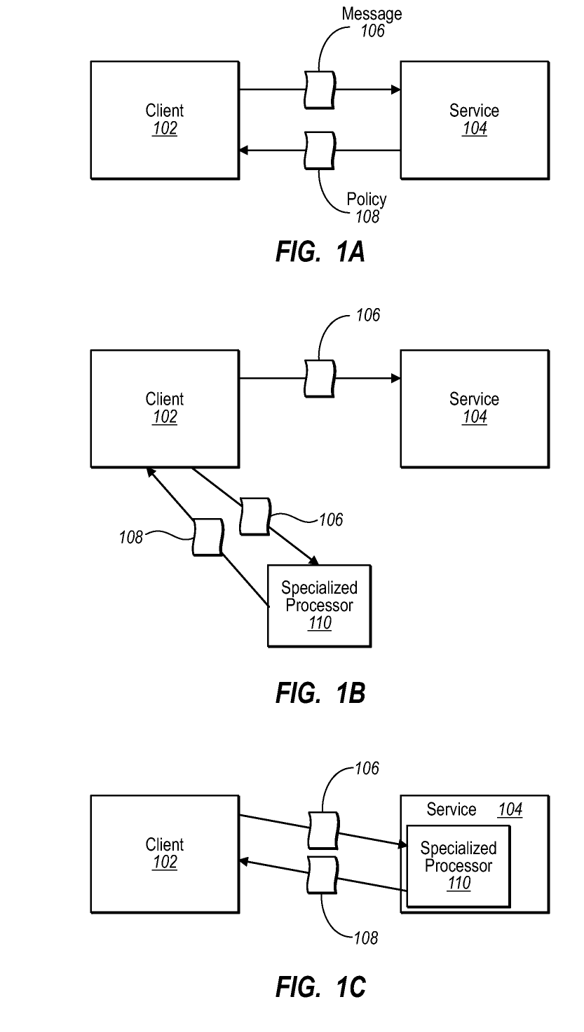

For example, attention is now directed to FIG. 1A. FIG. 1A illustrates a client 102 and a service 104. The service 104 includes functionality that can be accessed by the client 102 when a message complying with an appropriate policy is received. In the present embodiment shown in FIG. 1A, the service 104 includes additional functionality which allows the service 104 to evaluate messages sent from the client 102. If a message 106 sent from the client 102 is received by the service 104, and the message 106 complies with a policy particular to the message 106, the service 104 will provide the functionality requested by the message 106. However, if the message 106 does not comply with a policy particular to the message 106, the service 104 includes functionality for returning policy information 108 to the client 102 indicating the correct policy particular to the message 106.

In an alternative embodiment of the example shown in FIG. 1A, the service 104 may include functionality that specifically allows the client to request that the service 104 evaluate the message for compliance with a policy particular to the message. For example, this may be accomplished by wrapping the message 106 in a policy compliance request and/or including in the header of the message 106 an indicator that the message should be evaluated for compliance with a policy particular to the message 106. In some versions of this particular alternative embodiment, the service will not provide the functionality intended to be accessed by the message 106 irrespective of whether or not the message 106 complies with a policy particular to the message 106. Rather, the service 104 will return policy information 108 either indicating that the message complies with a policy particular to the message 106, or policy information indicating the correct policy. Once the client either knows that the message 106 complies with the policy particular to the message 106, or knows the correct policy particular to the message 106, the client 102 can then send a policy compliant message to the service 104 to access the functionality of the service 104 for which the message 106 was intended to access.

An alternative embodiment is illustrated in FIG. 1B. In the embodiment illustrated in FIG. 1B, a specialized processor 110 can be used to evaluate a message for compliance with a policy particular to message. For example, FIG. 1B illustrates a message 106 being sent from the client 102 to the specialized processor 110. The specialized processor 110 returns policy information 108 where the policy information 108 includes either an indication that the message 106 complies with a policy particular to the message 106 or an indication of the correct policy particular to the message 106. The client 102 can then access the functionality of the service 104 by sending the message 106 using the correct policy particular to the message 106 to the service 104 to access the functionality of the service 104 for which the message 106 is intended.

Yet another alternative embodiment is illustrated in FIG. 1C. In the example shown in FIG. 1C, the specialized processor 110 may be included in the service 104. As such the message 106 can be sent to the service 104 where it is routed to the specialized processor 110. The specialized processor 110, as in previous examples, can provide either an indication that the message complies with a policy particular to the message 106 or can provide policy information 108 particular to the message 106.

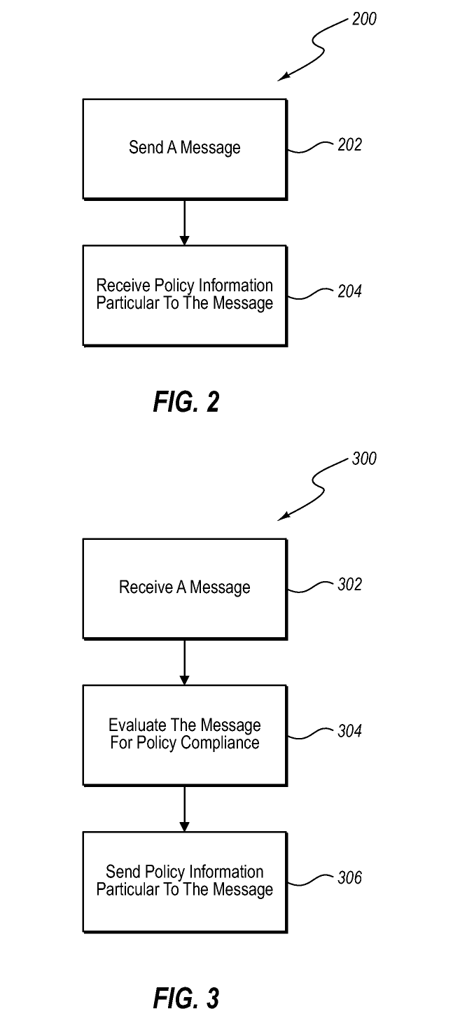

Reference is now made to FIG. 2, which illustrates a method of discerning appropriate policy for a particular message. The method 200 is generally illustrated as a method from a client, such as client 102, perspective. The method 200 illustrated in FIG. 2 may be practiced, for example, in a computing environment as described above. The method includes an act of sending a message (act 202). As illustrated in FIGS. 1A, 1B, and 1C, examples of sending a message 106 are illustrated by sending the message from the client 102 to one or more of a service 104, and/or a specialized processor 110.

The method 200 includes an act of receiving policy information particular to the message (act 204) in response to sending the message. The policy information may indicate that the message complies with a policy particular to the message when the message complies with a policy particular to the message. The policy information may indicate the correct policy if the message does not comply with the policy particular to the message.

As described previously, in one embodiment, sending a message (act 202) includes sending a message to a service. The message may be intended to access the functionality of the service. In one embodiment, the service is designed to provide the functionality if the message complies with the policy for a particular received message. The service may also be designed to respond with an indication of an appropriate policy for a particular received message when a particular received message does not comply with a policy for the particular received message. An example of a similar embodiment is illustrated and described previously in conjunction with FIG. 1A illustrated above.

Sending the message (act 202) may include sending an indicator with the message indicating that the message should be evaluated for proper policy for the particular message. For example, sending an indicator with the message may include sending a header with the message. The header may include an indication that the message should be checked for proper policy compliance. In one embodiment, when an indicator is sent with the message indicating that the message should be evaluated for proper policy, then the message is not processed to access the functionality of the service that the message is intended to access irrespective of whether or not the message complies with the appropriate policy. Rather, this mechanism can be used to discern appropriate policy and then to send the message at another appropriate time. In one embodiment, the method 200 may include sending an indicator with the message simply instructing the correct policy particular to the message to be returned. Thus, rather than requesting an evaluation of the message, a request for the correct policy for the message is sent with the message.

As illustrated in FIG. 1B the method 200 may be designed such that sending the message (act 202) includes sending the message to a specialized processor other than a service for which the message is intended to access the functionality of the service. The specialized processor is specifically implemented to verify a message's compliance to a particular policy for the particular message.

In one embodiment of the method 200, receiving policy information (act 204) may be performed in conjunction with error handling or processing at a client computer system. For example, receiving policy information may include receiving an error which contains policy information particular to the message. The error may be for example an application error or an infrastructure error. For example, an application error may be generated by the service 104 indicating that the message 106 has caused an error in an application running on the service 104. Alternatively, an error may be returned indicating that the message 106 is not appropriate for the infrastructure or the particular environment in which the client 102 and service 104 operate.

Referring now to FIG. 3, another method 300 is illustrated. The method 300 is generally illustrated from the perspective of a service or a specialized processor such as those shown in FIGS. 1A, 1B, and 1C. The method 300 may be practiced, for example, in a computing environment. The method includes acts for providing appropriate policy for a particular message. The method includes an act of receiving a message (act 302). For example, as illustrated above, a message 106 may be received at a service 104 and/or specialized processor 110 from a client 102.

The method 300 further includes an act of evaluating the message for compliance with a policy particular to the message (act 304). Policy information particular to the message may then be sent (act 306) depending on the outcome of the act of evaluating (act 304). For example, if the message does not comply with a policy particular to the message, policy information is sent (act 306), where the policy information indicates the correct policy particular to the message.

In one embodiment, a message may be received at a service where the message is intended to access functionality at the service. However, the message may not comply with a policy particular to the message. In these cases, embodiments may be such that sending policy information (act 306) provides the proper policy. If the message does comply with the policy particular to the message in this embodiment, then the functionality is simply provided instead of sending policy information particular to the message.

In other embodiments, if the message complies with a policy particular to the message, sending policy information (act 306) is done such that the policy information indicates that the message complies with a policy particular to the message. In one embodiment, this is performed if an indicator is received with the message indicating that the message should be evaluated for proper policy particular to the message. The indicator may be, for example, an indicator in the header of the message indicating that the message should be evaluated for policy compliance.

In one embodiment, the indicator may be included when the message is sent to a service that is able to provide the functionality for which the message is intended to access. For example, in FIG. 1A, the client 102 sends an indicator with message 106 to the service 104, where the service 104 includes functionality specifically intended to be accessed by the service 104. In some embodiments when an indicator is included with the message indicating that the message should be evaluated for policy compliance, a message is not processed to access functionality of the service for which the message is intended to access irrespective of whether or not the message complies with a policy particular to the message. Rather, the message is simply evaluated for compliance with the policy particular to the message.

In one embodiment, the method 300 may include in the act of sending policy information (306) an act of sending an application or infrastructure error, as described above. The application error may contain policy information particular to the message.

Sending policy information particular to the message (act 306) may be done such that if the message does not comply with a policy particular to the message, then the policy information indicates the correct policy particular to the message. Alternatively, if the message corn pies with a policy particular to the message the policy information indicates that the message complies with a policy particular to the message. In one embodiment, these alternative actions may be performed when receiving a message (act 302) is performed at a stand-alone service configured to evaluate messages for policy compliance. Such an example is illustrated above in FIG. 1B where the specialized processor functions as a stand-alone service configured to evaluation messages for policy compliance. Alternatively, these actions may be performed when receiving a message (act 302) is performed at a specialized; endpoint of a service for which the message is intended to access the functionality of the service. An example of this is illustrated in FIG. 1C, where the specialized processor 110 acts as a specialized endpoint of the service 104, when the service 104 includes functionality that can be accessed by policy compliant messages from the client 102.

In one embodiment messages can be wrapped in policy verification requests. For example, receiving an indicator in a header of a message may be one method of wrapping the message in a policy verification request.

Embodiments may be implemented within the context of Web Services. In particular, Web Services is a standardized way of integrating applications. Standardized XML documents can be used with SOAP (Simple Object Access Protocol) messages and WSDL (Web Services Description Language) descriptions to integrate applications without an extensive knowledge of the applications being integrated. Thus, the messages and replies may be sent using Web Services messages.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise physical computer readable media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of discerning appropriate policy for a particular message, the method comprising:
sending a message; and
in response to sending the message, receiving policy information, wherein the policy information either indicates that the message complies with a policy particular to the message or indicates the correct policy if the message does not comply with the policy particular to the message.

2. The method of claim 1, wherein sending a message comprises sending a message to a service, the message being intended to access the functionality of the service, and wherein the service is designed to provide the functionality if the message complies with the policy for a particular received message or to respond with an indication of an appropriate policy for a particular received message when a particular received message does not comply with a policy for the particular received message.

3. The method of claim 1, wherein sending the message comprises sending an indicator with the message indicating that the message should be evaluated for proper policy for the particular message.

4. The method of claim 3, wherein sending an indicator with the message comprises sending a header with the message, the header including an indication that the message should be checked for proper policy compliance.

5. The method of claim 3, wherein an indicator is sent with the message indicating that the message should be evaluated for proper policy, and wherein the message is not processed to access the functionality of the service that the message is intended to access irrespective of whether or not the message complies with the appropriate policy.

6. The method of claim 1, wherein sending the message comprises sending the message to a specialized processor other than a service for which the message is intended to access the functionality of the service, wherein the specialized processor is specifically implemented to verify a message's compliance to a particular policy for the particular message.

7. The method of claim 1, further comprising sending an indicator with the message instructing the correct policy particular to the message to be returned.

8. The method of claim 1, wherein receiving policy information comprises receiving an error which contains policy information particular to the message.

9. The method of claim 8, wherein the error is at least one of an application or a an infrastructure error.

10. In a computing environment, a method of providing appropriate policy for a particular message, the method comprising:
receiving a message;
evaluating the message for compliance with a policy particular to the message; and
if the message does not comply with a policy particular to the message, sending policy information, wherein the policy information indicates the correct policy particular to the message.

11. The method of claim 10, further comprising:
receiving an indicator with the message indicating that the message should be evaluated for proper policy particular to the message; and
if the message complies with a policy particular to the message, sending policy information, wherein the policy information indicates that the message complies with a policy particular to the message.

12. The method of claim 11, wherein the message is not processed to access functionality of the service for which the message is intended to access irrespective of whether or not the message complies with a policy particular to the message.

13. The method of claim 11, wherein receiving an indicator with the message comprises receiving an indicator in a header of the message.

14. The method of claim 10, wherein sending policy information comprises sending an error message which contains policy information particular to the message.

15. The method of claim 10, wherein receiving a message comprises receiving a message at a service for which the message is intended to access the functionality of the service.

16. In a computing environment, a method of providing appropriate policy for a particular message, the method comprising:
receiving a message;
evaluating the message for compliance with a policy particular to the message;
if the message does not comply with a policy particular to the message, sending policy information, wherein the policy information indicates the correct policy particular to the message; or
if the message complies with a policy particular to the message, sending policy information, wherein the policy information indicates that the message complies with a policy particular to the message.

17. The method of claim 16, wherein receiving a message comprises receiving a message at a stand-alone service configured to evaluate messages for policy compliance.

18. The method of claim 16, wherein receiving a message comprises receiving a message at a specialized endpoint of a service for which the message is intended to access the functionality of the service.

19. The method of claim 18, wherein the message is wrapped in a policy verification request.

20. The method of claim 19, further comprising receiving an indicator in a header of the message.
